(19) United States
(12) Patent Application Publication
(10) Pub. No.: US 2024/0400117 A1
(43) Pub. Date: Dec. 5, 2024

(54) A HEAT PUMP HVAC SYSTEM

(71) Applicant: Knorr-Bremse Australia Pty Ltd, Hornsby, New South Wales (AU)

(72) Inventor: Stuart MORLEY, Hornsby, New South Wales (AU)

(73) Assignee: Knorr-Bremse Australia Pty Ltd, Hornsby, New South Wales (AU)

(21) Appl. No.: 18/690,929

(22) PCT Filed: Sep. 12, 2022
(86) PCT No.: PCT/AU2022/051101

§ 371 Date: Mar. 11, 2024

(30) Foreign Application Priority Data
Sep. 14, 2021 (AU) 2021902961

(51) Int. Cl. B61D 27/00

(52) U.S. Cl. CPC B61D 27/0018

(57) ABSTRACT

Heat pump HVAC systems are described including: an inside coil; a compressor; and an outside coil; wherein the outside coil includes first and second interlaced circuits. In some embodiments in a cooling mode both of the interlaced circuits are used as condensers, and in a heating mode only the first interlaced circuit is used as an evaporator.

### TECHNICAL FIELD

The present invention relates to heat pump HVAC systems and particularly relates to a heat pump HVAC system that is intended for us in the driver's cabin of a locomotive.

### BACKGROUND TO THE INVENTION

Railway locomotives are used in a wide range of locations and are expected to operate in both extreme high or low ambient temperatures. For the comfort and safety of the driver, it is essential to regulate the air temperature in the driver's cabin.

Heat pump type HVAC systems offer the benefits of being able to work in both forward and reverse cycles. This means that the same system can work in either a heating mode or a cooling mode, depending upon the current conditions.

A challenge arises in the use of a heat pump HVAC system to regulate the temperature of the driver's cabin of a railway locomotive and this is related to the small volume of air in the driver's cabin.

A heat pump working in heat mode has the inside coil providing heat and the outside coil cooling the outside air (the reverse cycle). This means on a cold ambient day (ambient <5 C) the outside coil can ice up as water in the air freezes on the outside coil.

One approach to the problem of dealing with ice build up is known as “Defrost mode”. Defrost mode basically means regularly changing from the heat cycle to the cooling cycle to warm up the outside coil and remove ice. During the time that the unit is put into the cooling cycle, the inside coil becomes cold. This technique works in large spaces in houses, offices and even passenger trains because the volume of air is such that the short period of the unit running in the cooling cycle does not have a significant effect on the air temperature in the space, and so the occupants do not generally notice any drop in air temperature.

However, in a driver's cabin the volume of air is comparatively small. The air from the HVAC unit will be blowing almost directly onto the driver's face and feet etc. The use of defrost mode means then that for a time the driver is very likely to notice the heating has stopped and has changed to cooling mode. This is not comfortable for the driver.

Another method which avoids the icing of the outside coil is to use supplementary electric heaters to warm up the coil. However, these electric heaters add complexity to the design of the HVAC system, consume energy and require their own safety switches.

There remains a need to provide improved heat pump HVAC systems which address the above-mentioned problems.

### SUMMARY OF THE INVENTION

In a first aspect the present invention provides a heat pump HVAC system including: an inside coil: a compressor; and an outside coil; wherein the outside coil includes first and second interlaced circuits.

When the system is in a cooling mode both of the interlaced circuits may be used as condensers, and in a heating mode only the first interlaced circuit may be used as an evaporator.

When the system is in a heating mode heat may be applied to the second interlaced circuit to counteract the formation of ice on the outside coil.

The system may be arranged to apply heat to the second interlaced circuit by directing hot discharge from the compressor to the second interlaced circuit.

The hot discharge from the compressor may be directed to the second interlaced circuit by way of a pulse valve.

The pulse valve may be arranged to operate based on the output of a temperature sensor that is associated with the outside coil.

The system may further include an expansion valve associated with the inside coil: an expansion valve associated with the outside coil; and a controller; wherein the controller controls the operation of the expansion valves and also control the operation of the compressor.

In a second aspect the present invention provides a railway locomotive including a heat pump HVAC system according to any preceding claim.

### BRIEF DESCRIPTION OF THE DRAWINGS

An embodiment of the present invention will now be described, by way of example only, with reference to the accompanying drawings, in which:

FIG. 1 is a schematic diagram of a heat pump HVAC system in a cooling mode;

FIG. 2 shows the heat pump HVAC system of FIG. 1 in a heating mode:

FIG. 3 is a list of the parts identified by the reference numerals used in FIGS. 1 and 2; and

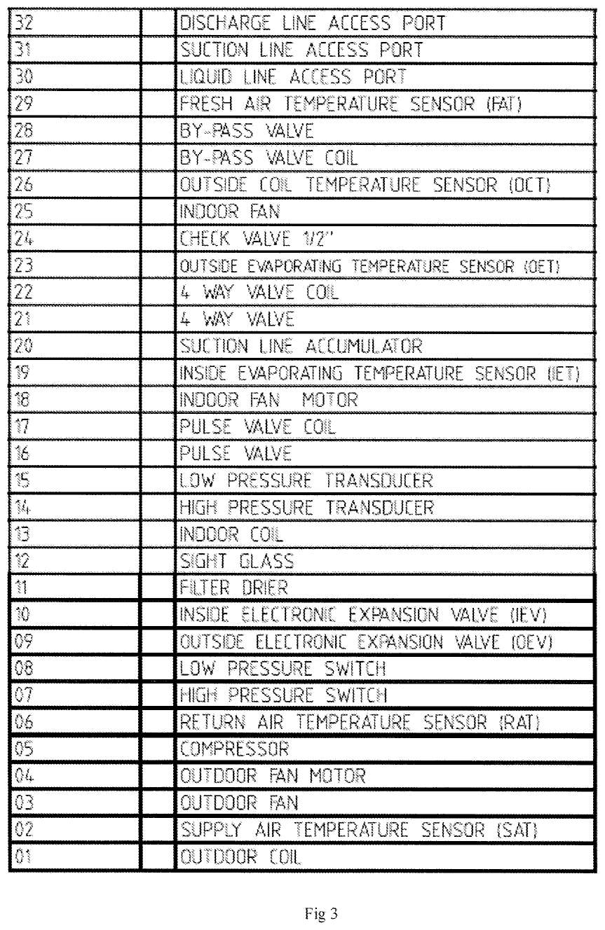

FIG. 4 shows an example of the physical arrangement of interlaced circuits in a coil.

### DETAILED DESCRIPTION OF THE PREFERRED EMBODIMENT

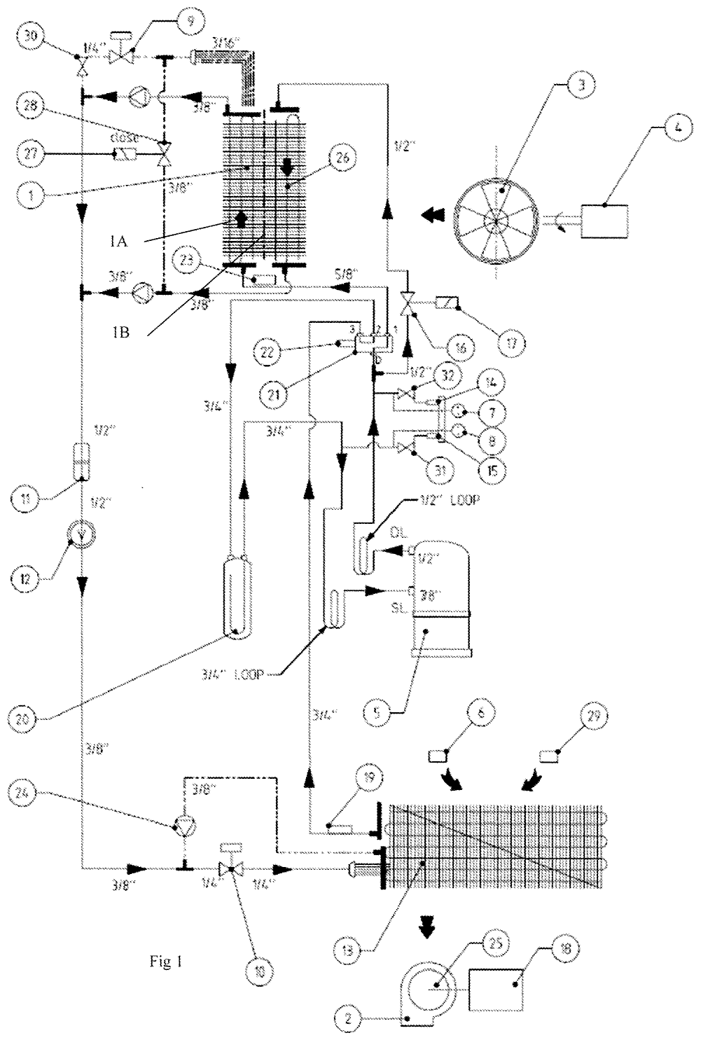

Referring to FIG. 1, an HVAC system for a railway locomotive is shown including an inside coil 13: a compressor 5; and an outside coil 1. The compressor 5 is used to pump a refrigerant between the outside and inside coils in one of two modes, a cooling mode and a heating mode as is well known in the art.

The outside coil includes two interlaced flowpaths or circuits 1A and 1B. The circuits 1A and 1B are of similar capacity and are similarly sized.

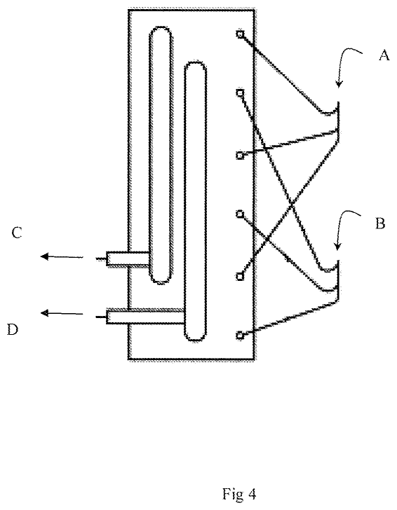

In FIG. 1, the circuits 1A and 1B are illustrated schematically side by side for ease of illustration. In practice, the circuits are physically convoluted together in an interlaced fashion as shown in FIG. 4 with alternate rows of the two circuits being arranged side by side to provide for good heat exchange between the two circuits.

In FIG. 4, refrigerant in two circuits A, B is distributed to alternate tubes in the coil. The outlets of the tubes making up circuit A are joined together and refrigerant emanates at C. Similarly, the outlets of the tubes making up circuit B are joined together and refrigerant emanates at D. The general concept of interlacing circuits is known to those skilled in the art of heat exchangers.

In the cooling mode shown in FIG. 1, both of circuits 1A and 1B operate in parallel as condensers, rejecting heat to the atmosphere. The inside coil 13 operates as an evaporator to cool the air inside the driver's cabin with the aid of a fan 25 as is well known.

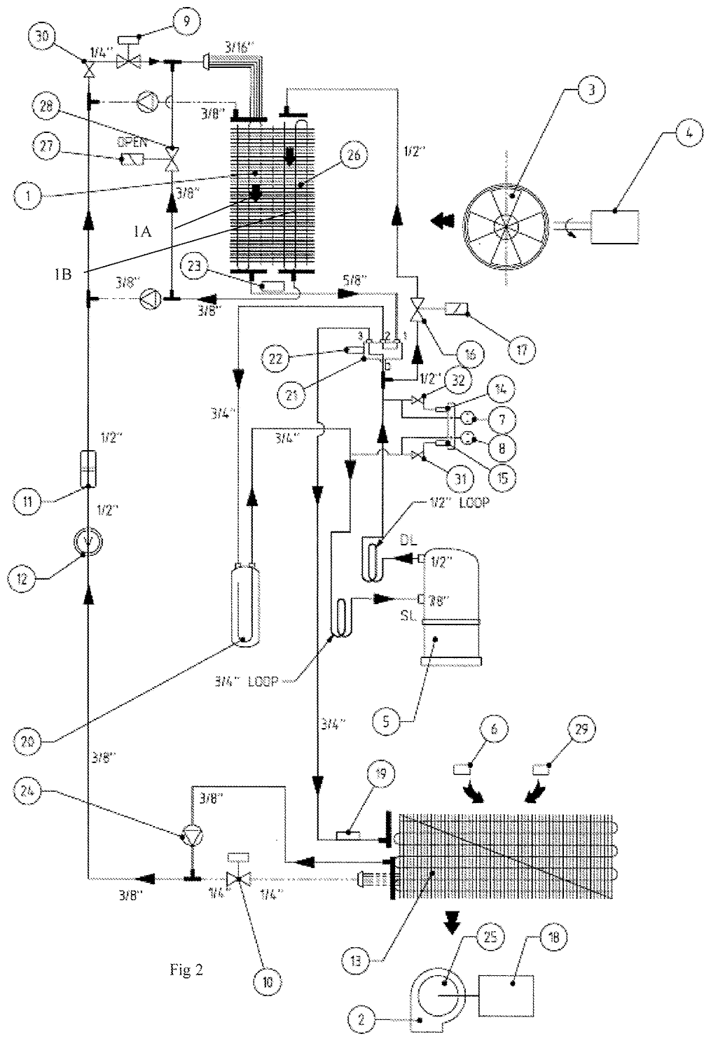

Referring now to FIG. 2, in the heating mode, only the first circuit 1A of the outside coil 1 acts as an evaporator, drawing heat from the atmosphere. The inside coil 13 operates as a condenser to heat the air inside the driver's cabin.

During operation in the heating mode, the temperature of the outside coil 1 is monitored by temperature sensor 26. A low threshold temperature value below which ice build up may occur on the outside coil is stored in the system. If the low threshold temperature is reached then heat is applied to the second circuit 1B to counteract the formation of ice on the outside coil.

Heat is applied to the second circuit 1B by operating a pulse valve 16. This causes hot discharge from the compressor to flow through the second interlaced circuit.

The warming of the outside coil when ice formation is imminent allows the HVAC system to keep running in heat mode without going into a defrost mode or vent mode and without the use of supplementary heaters. It also is energy efficient as the energy warming up the outside coil means the inside coil also runs at a higher temperature providing heating in the driver's cabin.

Furthermore, for efficient and effective HVAC operation the condenser is usually sized to be 30% bigger than the evaporator. This means that for cooling (the normal reason for having a HVAC system), the inside coil is smaller than the outside coil by around 30%. When running a traditional system in reverse for heating, this means that the outside coil is oversized, which is not an optimal situation.

In the system shown in FIGS. 1 and 2, the two interlaced circuits 1A and 1B are sized so that together they are 30% larger than the inside coil. This meets optimal sizing for the cooling mode.

When in the heating mode, only one of the outside circuits is used, this has the effect of better balancing the size of the coils when in the heating mode i.e. the condenser (the inside coil) is of a size which is about 30% larger than the evaporator (being only one of the circuits 1A or 1B in the outside coil). This improved balancing in the heating mode improves efficiency.

Typically a locomotive has an alternator or generator which produces a low voltage DC supply. The system of figure uses an inverter to invert this to a 3 phase AC supply suitable for powering the fan motors and the compressor. This provides variable speed drive to compressor and fans also helping stable control of heating and cooling.

In the system shown in FIGS. 1 and 2, the expansion valves do not have their own controllers but are directly controlled with the same controller (not shown) as operates the variable speed drive and heat cycle functions including operating the pulse valve pulse valve. This assists in stable control of heating and cooling functions.

It can be seen that embodiments of the invention have at least one of the following advantages:
Ice build up on out side coil is addressed without any cessation of heated air
System is better balanced in heating mode than a traditional system with a single outside coil.

Any reference to prior art contained herein is not to be taken as an admission that the information is common general knowledge, unless otherwise indicated.

Finally, it is to be appreciated that various alterations or additions may be made to the parts previously described without departing from the spirit or ambit of the present invention.

1-8. (canceled)

9. A heat pump HVAC system comprising:
an inside coil;
a compressor; and
an outside coil;
the outside coil includes first and second interlaced circuits;
in a cooling mode both of the first and the second interlaced circuits are used as condensers, and in a heating mode only the first interlaced circuit is used as an evaporator;
in the heating mode heat is applied to the second interlaced circuit to counteract the formation of ice on the outside coil; and
wherein the system is arranged to apply heat to the second interlaced circuit by directing hot discharge from the compressor to the second interlaced circuit.

10. The heat pump HVAC system according to claim 9, wherein the hot discharge from the compressor is directed to the second interlaced circuit by way of a pulse valve.

11. The heat pump HVAC system according to claim 10, wherein the pulse valve is arranged to operate based on the output of a temperature sensor that is associated with the outside coil.

12. A heat pump HVAC system according to claim 9, further including:
an expansion valve associated with the inside coil;
an expansion valve associated with the outside coil; and
a controller;
wherein the controller controls the operation of the expansion valves and also controls the operation of the compressor.

13. A railway locomotive including a heat pump HVAC system according to claim 9.
